(19) United States
(12) Patent Application Publication
(10) Pub. No.: US 2012/0293711 A1
(43) Pub. Date: Nov. 22, 2012

(54) IMAGE PROCESSING APPARATUS, METHOD, AND PROGRAM

(75) Inventor: Kazunori KAMIO, Kanagawa (JP)

(73) Assignee: SONY CORPORATION, Tokyo (JP)

(21) Appl. No.: 13/459,589

(22) Filed: Apr. 30, 2012

(30) Foreign Application Priority Data
May 18, 2011 (JP) 2011-111311

(51) Int. Cl. H04N 7/01

(52) U.S. Cl. 348/448; 348/E07.003

(57) ABSTRACT

There is provided an image processing apparatus that converts an interlaced signal to a progressive signal, including: a field difference calculating unit calculating a field difference that is a difference between consecutive fields in the interlaced signal; a field resolution calculating unit calculating a field resolution that is a resolution of a field in the interlaced signal; a field correlation determining unit determining correlation between the consecutive fields based on the field difference and the field resolution; and an interpolated image deciding unit deciding the fields to be used in an interpolation process for obtaining the progressive signal based on a determination result produced by the field correlation determining unit.

### BACKGROUND

The present disclosure relates to an image processing apparatus, method, and program. In particular, the present disclosure relates to an image processing apparatus, method, and program that are capable of carrying out suitable IP (Interlaced to Progressive) conversion on an input signal with an arbitrary pulldown sequence.

There are existing techniques for detecting pulldown sequences such as 2-2 pulldown and 2-3 sequences as pulldown sequences of telecine images that have been subjected to telecine conversion (see, for example, Japanese Laid-Open Patent Publications No. 2005-72863 and H08-289199).

By using such techniques to detect pull-down sequences, it is possible to correctly carry out pulldown removal.

### SUMMARY

With the techniques mentioned above, since a large buffer is necessary to analyze the pulldown sequences, the detection of pulldown sequences has been carried out in the past on the assumption that a given pulldown sequence indicated in advance is repeated.

Meanwhile, image signals with a variety of pulldown sequences have been used in recent years.

Although it is also necessary to detect pulldown sequences when carrying out pulldown removal on such image signals, with the techniques mentioned above, it has not been possible to detect pulldown sequences aside from 2-2 pulldown and 2-3 pulldown.

Also, if an interpolation pair is decided when interpolating an image after pulldown removal, it would be possible in the telecine conversion to decide the interpolation pair based on a difference between frames. However, since it is necessary during IP conversion that converts an interlaced signal to a progressive signal to set first and second fields as an interpolation pair, even if the interpolation pairs were decided based on a difference between fields, it would not be possible to suitably decide the interpolation pairs due to the large effect of the phase difference that is characteristic to interlacing.

The present disclosure aims to make it possible to carry out suitable IP conversion on an input signal with an arbitrary pulldown sequence.

According to an embodiment of the present disclosure, there is provided an image processing apparatus that converts an interlaced signal to a progressive signal, which includes a field difference calculating unit calculating a field difference that is a difference between consecutive fields in the interlaced signal, a field resolution calculating unit calculating a field resolution that is a resolution of the fields in the interlaced signal, a field correlation determining unit determining correlation between the consecutive fields based on the field difference and the field resolution, and an interpolated image deciding unit deciding the fields to be used in an interpolation process for obtaining the progressive signal based on a determination result produced by the field correlation determining unit.

The field difference calculating unit may calculate the field difference between a focus field presently in focus and a previous field that comes before the focus field in a time series. The field resolution calculating unit may calculate the field resolution of the focus field. The field correlation determining unit may determine the correlation between the focus field and the previous field based on the field difference and the field resolution. The interpolated image deciding unit may be operable when it has been determined that the correlation is higher than a specified threshold to select the focus field and the previous field as the fields to be used in the interpolation process and may be operable when it has been determined that the correlation is not higher than a specified threshold to select the focus field and a following field that comes after the focus field in the time series as the fields to be used in the interpolation process.

The image processing apparatus may further include a signal determining unit determining, based on the determination result of the field correlation determining unit, whether the interlaced signal is a pulldown signal that has been pulled down according to a specified sequence, and a signal output unit operable when the signal determining unit has determined that the interlaced signal is a pulldown signal, to output the progressive signal obtained by the interpolation process using the fields decided by the interpolated image deciding unit.

According to another embodiment of the present disclosure, there is provided an image processing method for an image processing apparatus that converts an interlaced signal to a progressive signal, including calculating a field difference that is a difference between consecutive fields in the interlaced signal, calculating a field resolution that is a resolution of the fields in the interlaced signal, determining correlation between the consecutive fields based on the field difference and the field resolution, and deciding the fields to be used in an interpolation process for obtaining the progressive signal based on the determined correlation between the fields.

According to another embodiment of the present disclosure, there is provided a program causing a computer to carry out processing that converts an interlaced signal to a progressive signal, the processing including calculating a field difference that is a difference between consecutive fields in the interlaced signal, calculating a field resolution that is a resolution of the fields in the interlaced signal, determining correlation between the consecutive fields based on the field difference and the field resolution, and deciding the fields to be used in an interpolation process for obtaining the progressive signal based on a determination result produced by the process of determining correlation between the fields.

According to one aspect of the present disclosure, a field difference that is a difference between consecutive fields in an interlaced signal is calculated, a field resolution that is a resolution of the fields in the interlaced signal is also calculated, the correlation between consecutive fields is determined based on the field difference and the field resolution, and the fields to be used in an interpolation process for obtaining a progressive signal are decided based on a determination result for the field correlation.

According to the embodiments of the present disclosure described above, it is possible to carry out appropriate IP conversion on an input signal with an arbitrary pulldown sequence.

### BRIEF DESCRIPTION OF THE DRAWINGS

FIG. 1 is a diagram useful in explaining an overview of IP conversion;

FIG. 2 is a diagram useful in explaining normal IP conversion;

FIG. 3 is a diagram useful in explaining IP conversion according to an embodiment of the present disclosure;

FIG. 4 is a diagram useful in explaining the interpolation pairs used for focus fields in input images with different pulldown sequences;

FIG. 5 is a block diagram showing an example of the functional configuration of one embodiment of an image processing apparatus according to an embodiment of the present disclosure;

FIG. 6 is a flowchart useful in explaining an IP conversion process;

FIG. 7 is a diagram useful in explaining field difference and field resolution;

FIG. 8 is a diagram useful in explaining how an interpolation pair is decided based on field correlation; and

FIG. 9 is a block diagram showing an example of the hardware configuration of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The embodiments of the present disclosure are described with reference to the drawings in the order indicated below.

1. Overview of IP Conversion

2. Normal IP Conversion

3. IP Conversion According to Embodiment of the Present Disclosure

4. Configuration of Image Processing Apparatus according to Embodiment of the Present Disclosure

5. IP Conversion Process

1. Overview of IP Conversion

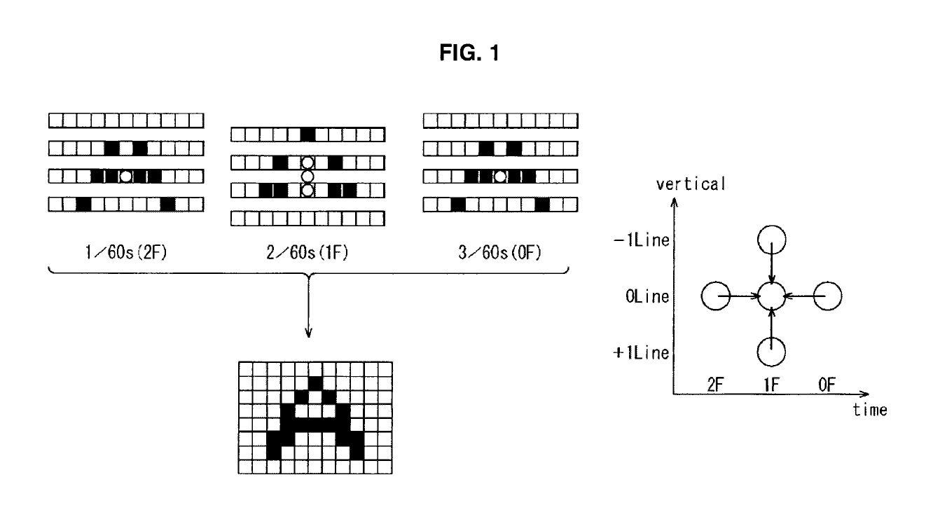

First, an overview of IP conversion will be described with reference to FIG. 1. IP conversion is a process that converts an interlaced signal to a progressive signal.

In an IP conversion process, as shown on the left in FIG. 1, a frame of a progressive signal shown in the lower left in FIG. 1 is generated by generating an interpolated line (0 line) for a 1st field from three fields of an inputted interlaced signal, that is, a 0th field, a 1st field, and a 2nd field (hereinafter referred to as “0 F”, “1 F”, and “2 F”). More specifically, a pixel (pixel value) on the 0th line of 1 F is generated based on pixels on the 0 lines of 0 F and 2 F and pixels of the +1 line and −1 line of 1 F as shown on the left in FIG. 1.

2. Normal IP Conversion

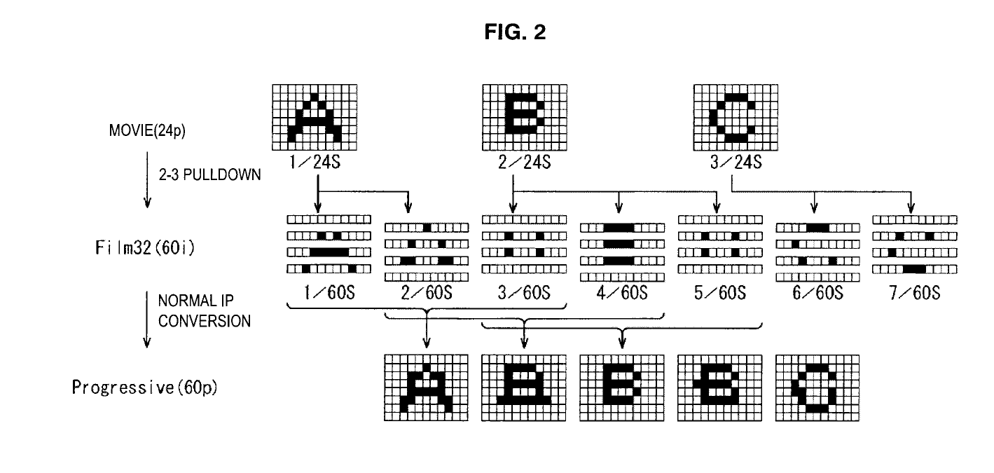

Next, an example of normal IP conversion will be described with reference to FIG. 2.

FIG. 2 shows an example where an interlaced signal that was subjected to 2-3 pulldown is converted to a progressive signal.

In FIG. 2, a movie with a frame rate of 24 Hz is subjected to 2-3 pulldown to generate television images that are an interlaced signal (hereinafter referred to as appropriate as “interlaced images”) with a field frequency of 60 Hz, and such television images are subjected to IP conversion to generate images of a progressive signal (hereinafter referred to as appropriate as “progressive images”) with a frame rate of 60 Hz.

More specifically, the first and second fields of the television images are generated from the image A that is the first frame of the movie, the third, fourth, and fifth fields of the television images are generated from the image B that is the second frame of the movie, and the sixth and seventh fields of the television images are generated from the image C that is the third frame of the movie.

Also, the first frame of the progressive images is generated from the first, second, and third fields of the television images, the second frame of the progressive images is generated from the second, third, and fourth fields of the television images, and the third frame of the progressive images is generated from the third, fourth, and fifth fields of the television images, with subsequent frames of the progressive images being generated in the same way thereafter.

However, fields in the interlaced images that were generated from different movie frames will become mixed in the frames of the progressive images obtained by the IP conversion described above. As a specific example, the first frame in the progressive images in FIG. 2 is generated from two fields generated from the image “A” in the first frame of the movie and a field generated from the image “B”.

Accordingly, the image quality of the progressive images obtained in this way is not very high.

3. IP Conversion According to Embodiment of the Present Disclosure

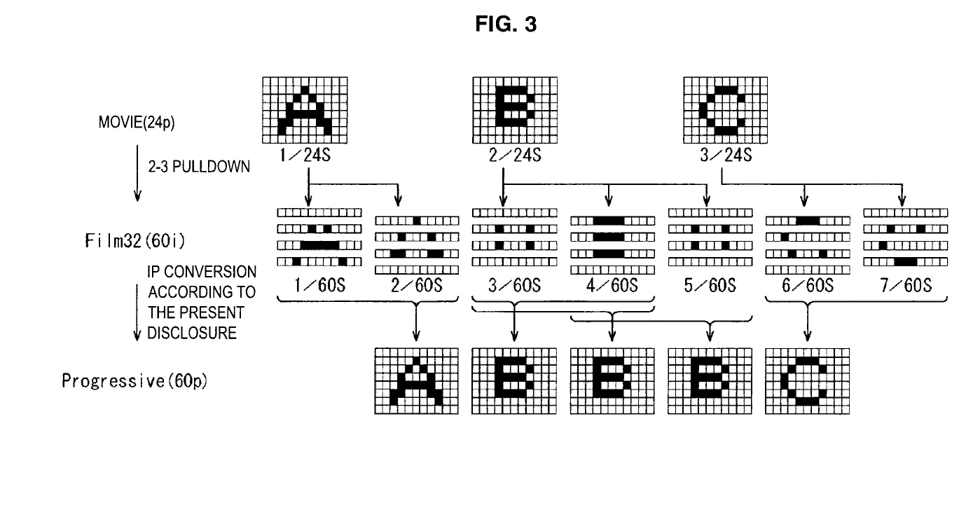

Next, an example of IP conversion according to an embodiment of the present disclosure will be described with reference to FIG. 3.

In the same way as FIG. 2, FIG. 3 shows an example where an interlaced signal that was subjected to 2-3 pulldown is converted to a progressive signal.

However, in FIG. 3, the first frame of the progressive images is generated from the first and second fields of the television images, the second and third frames of the progressive images are generated from the third and fourth fields of the television images, the fourth frame of the progressive images is generated from the fourth and fifth fields of the television images, and the fifth frame of the progressive images is generated from the sixth and seventh fields of the television images.

That is, in the IP conversion shown in FIG. 3, if 1 F in FIG. 1 is set as the focus field, the frame in the progressive image corresponding to the focus field is generated by interpolation based on 1 F and one of 0 F (that is, the following field in a time series) and 2 F (that is, the preceding field in a time series).

More specifically, in the IP conversion shown in FIG. 3, when the focus field has been shifted from the first field, interpolation is carried out based on the focus field (1 F) and 2 F for the second field, 0 F for the third field, 2 F for the fourth field, 2 F for the fifth field, and OF for the sixth field, with such order being repeated thereafter.

In this way, for interlaced images that have been subjected to 2-3 pulldown, the field paired with the focus field (1 F) in an interpolation pair changes in the order 2 F, 0 F, 2 F, 0 F, 2 F, and 0 F, with such order being repeated thereafter.

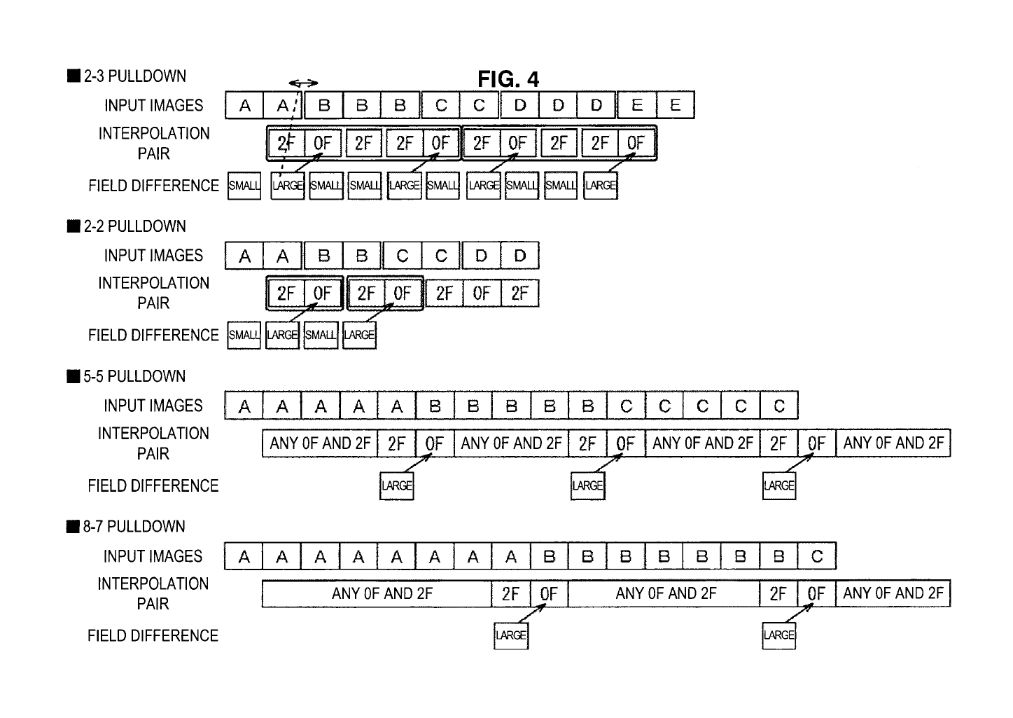

FIG. 4 is a diagram useful in explaining the interpolation pairs used for focus fields in input images with different pulldown sequences. In FIG. 4, the interpolation pairs used for focus fields in input images are shown for 2-3 pulldown, 2-2 pulldown, 5-5 pulldown, and 8-7 pulldown in that order from the top.

As shown in FIG. 4, for 2-3 pulldown, as described with reference to FIG. 3, the interpolation pairs for the input images change in the order of 2 F, 0 F, 2 F, 2 F, and 0 F, with such order being repeated thereafter. For 2-2 pulldown, the interpolation pairs for the input images change in the order of 2 F, 0 F, with such order being repeated thereafter. For 5-5 pulldown, the interpolation pairs for the input images change in the order of X, X, X, 2 F, 0 F, with such order being repeated thereafter. For 8-7 pulldown, the interpolation pairs for the input images change in the order of X, X, X, X, X, X, 2 F, 0 F, X, X, X, X, X, 2 F, 0 F, with such order being repeated thereafter. Note that “X” indicates that any of “0 F” and “2 F” may be used.

Since there will be no mixing of fields generated from different movie frames in a frame of progressive images obtained by deciding the interpolation pairs in this way, the image quality of the progressive images is favorable.

Although it is possible to decide the field to be paired with the focus field in an interpolation pair as shown in FIG. 4 when the pulldown sequence is known in advance, such as 2-3 pulldown described above or 2-2 pulldown, if the pulldown sequence is not known in advance, it is not possible to decide the field to be paired with the focus field in an interpolation pair as shown in FIG. 4.

For this reason, according to an embodiment of the present disclosure, the field to be paired with the focus field in an interpolation pair is decided by focusing on the difference between fields (hereinafter, “field difference”).

In FIG. 4, for all of the pulldown sequences, when there is a large field difference between the focus field and the following field, 0 F is definitely chosen for the interpolation pair for the next focus field.

That is, even if the pulldown sequence is not known in advance, the interpolation pair of the next focus field is decided based on the field difference between the present focus field and the next field. In other words, the interpolation pair for each present focus field currently in focus is decided based on the field difference between such present focus field and the preceding field in a time series.

However, as can be understood by comparing 0 F and 1 F of the interlaced signal in FIG. 1 for example, the field difference is highly affected by the phase difference that is characteristic to interlaced signals so that even consecutive fields generated from the same image (frame) will be different images. In particular, if the vertical resolution is high (near ½ of the Nyquist frequency for progressive images), the field difference tends to be large.

For this reason, according to an embodiment of the present disclosure, the interpolation pair for the focus field is decided based on the field difference in keeping with the vertical resolution of the field image (hereinafter referred to as the “field resolution”).

4. Configuration of Image Processing Apparatus according to Embodiment of the Present Disclosure

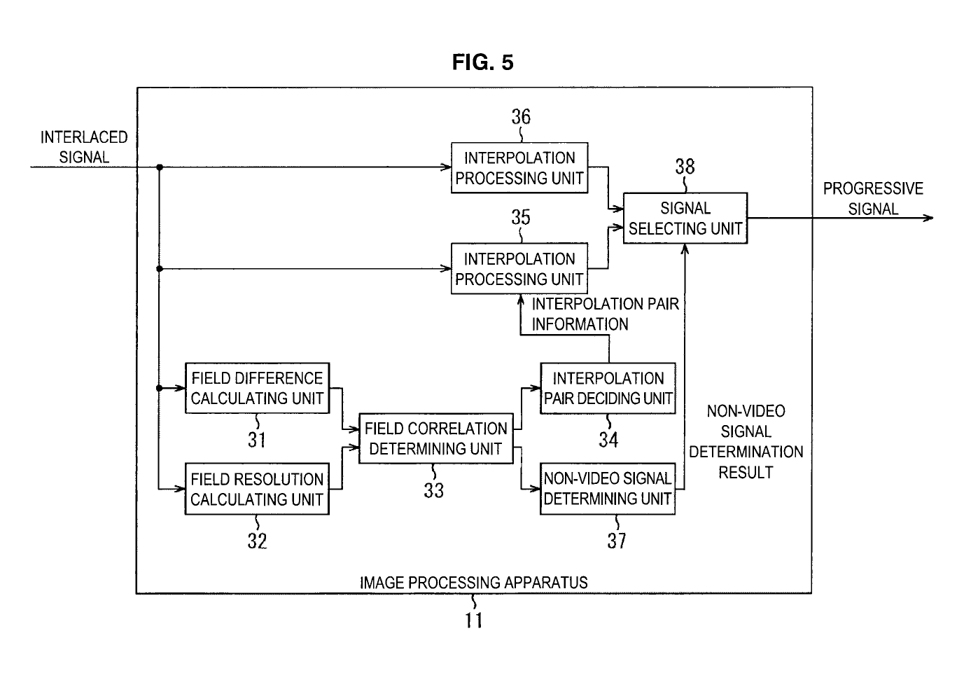

FIG. 5 shows the configuration of an embodiment of an image processing apparatus according to an embodiment of the present disclosure.

The image processing apparatus 11 in FIG. 5 carries out an IP conversion process on input images as an interlaced signal to output output images as a progressive signal.

The image processing apparatus 11 shown in FIG. 5 includes a field difference calculating unit 31, a field resolution calculating unit 32, a field correlation determining unit 33, an interpolation pair deciding unit 34, an interpolation processing unit 35, an interpolation processing unit 36, a non-video signal determining unit 37, and a signal selecting unit 38.

The field difference calculating unit 31 calculates the field difference between consecutive fields in the inputted interlaced signal and supplies the field difference to the field correlation determining unit 33.

The field resolution calculating unit 32 calculates the field resolution of a field in the inputted interlaced signal and supplies the field resolution to the field correlation determining unit 33.

The field correlation determining unit 33 determines whether the field correlation, which expresses the correlation between consecutive fields, is high or low based on the field difference from the field difference calculating unit 31 and the field resolution from the field resolution calculating unit 32, and supplies the determination result to the interpolation pair deciding unit 34 and also supplies the field difference and the field resolution to the non-video signal determining unit 37.

The interpolation pair deciding unit 34 decides the field to be paired with the focus field in an interpolation pair based on the determination result from the field correlation determining unit 33 and supplies interpolation pair information showing the interpolation pair to the interpolation processing unit 35.

The interpolation processing unit 35 carries out interpolation on fields of the inputted interlaced signal based on the interpolation pair information from the interpolation pair deciding unit 34 and supplies the obtained progressive signal to the signal selecting unit 38.

The interpolation processing unit 36 carries out interpolation on a focus field in the inputted interlaced signal based on the preceding and following fields and supplies the obtained progressive signal to the signal selecting unit 38. More specifically, the interpolation processing unit 36 interpolates a pixel on an interpolated line in the focus field based on pixels on interpolated lines in the preceding and following fields for the focus field and pixels on higher and lower lines than the interpolated line in the focus field. In the interpolation processing unit 36, interpolation (hereinafter, referred to as “video interpolation”) is carried out according to the IP conversion described with reference to FIG. 2, and if the input signal is an interlaced signal that has not been subjected to pulldown processing but has been picked up at equal time intervals (hereinafter such a signal is referred to as a “video signal”), such signal will be converted to an appropriate progressive signal.

The non-video signal determining unit 37 determines, based on the field difference and the field resolution from the field correlation determining unit 33, whether the interlaced signal is a video signal and supplies a determination result to the signal selecting unit 38.

The signal selecting unit 38 selects, based on the determination result from the non-video signal determining unit 37, whether to output the progressive signal from the interpolation processing unit 35 or the progressive signal from the interpolation processing unit 36.

5. IP Conversion Process

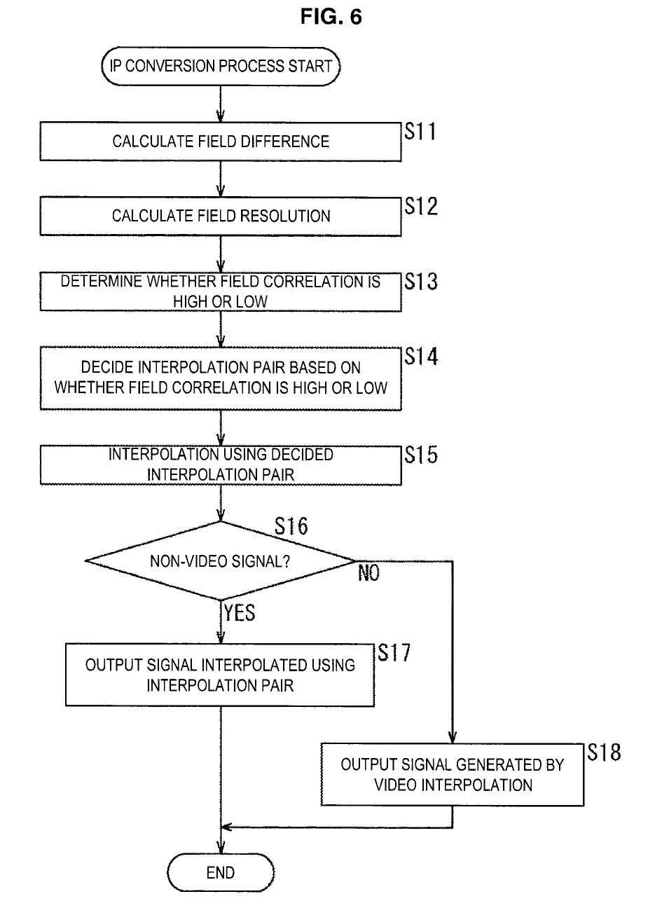

Next, the IP conversion process carried out by the image processing apparatus 11 will be described with reference to FIG. 6.

In step S11, the field difference calculating unit 31 calculates the field difference between the focus field in the interlaced signal that is being inputted and the previous field in a time series (hereinafter referred to as the “previous field”) and supplies the field difference to the field correlation determining unit 33.

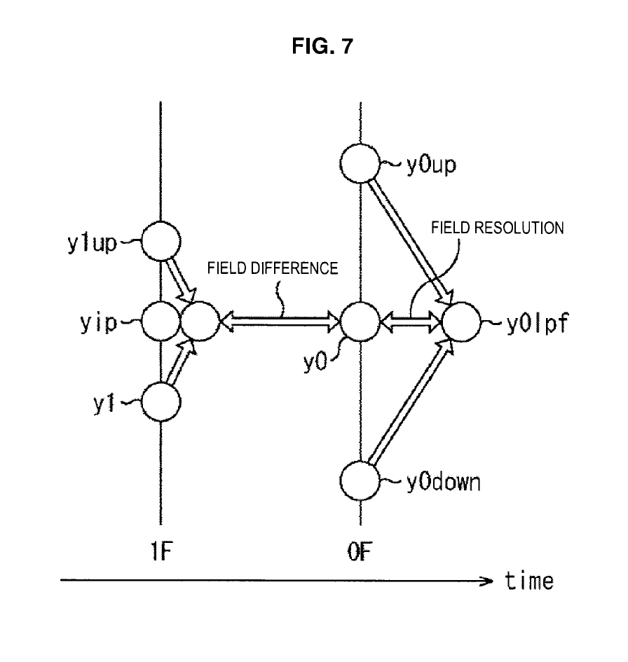

More specifically, as shown in FIG. 7, if 0 F is set as the focus field, a focus pixel (pixel value, hereinafter the expression “pixel” refers to a “pixel value”) in 0 F is set as “y0”, a pixel in the previous field (1 F) that corresponds to the focus pixel y0 is set as “yip”, a pixel in the next line above the pixel yip is set as “y1up”, and a pixel in the next line below the pixel yip is set as “y1”, the field difference for the focus field is given by Equation (1) below.

Field Difference)=Σ|yip−y0|=Σ|y1up−2y0+y1|/2 (1)

In step S12, the field resolution calculating unit 32 calculates the field resolution that is the vertical resolution of the focus field (0 F) in the interlaced signal being inputted and supplies the calculated field resolution to the field correlation determining unit 33.

More specifically, as shown in FIG. 7, if a pixel two lines above the focus pixel y0 in the focus field (0 F) is set as “y0up”, a pixel two lines below the focus pixel y0 is set as “y0down”, and a pixel calculated from the pixel y0up and the pixel y0down is set as “y01pf”, the field resolution of the focus field is given by Equation (2) below.

(Field Resolution)=σ|y01pf−y0|=σ|y0up−2y0+y0down|/2 (2)

In step S13, the field correlation determining unit 33 calculates the field correlation between the focus field (0 F) and the previous field (1 F) based on the field difference from the field difference calculating unit 31 and the field resolution from the field resolution calculating unit 32 to determine whether the field correlation is high or low.

Here, the field difference given by Equation (1) described above is a (−1, 2, −1) filter for the focus pixel and the pixels one line above and one line below the focus pixel in a progressive image corresponding to the focus field. The field resolution given by Equation (2) described above is a (−1, 0, 2, 0, −1) filter for the focus pixel, the pixels two lines above and two lines below the focus pixel, and the pixels one line above and one line below the focus pixel in a progressive image corresponding to the focus field.

That is, the field correlation determining unit 33 calculates the correlation between the filtering results produced by such vertical bandpass filters.

More specifically, the field correlation determining unit 33 determines that the field correlation is high when Equation (3) below is satisfied.

(Field Difference)<(Field Resolution)/2+register (3)

According to Equation (3), “(Field Resolution)/2” is set as a threshold and when the field difference is lower than the threshold, the field correlation is determined to be high. Here, “register” is a value for adjusting the threshold “(Field Resolution)/2”, which is a logical value, in keeping with fluctuations in noise.

The field correlation determining unit 33 supplies the determination result, that is, whether the field correlation is high or low, to the interpolation pair deciding unit 34 and also supplies the field difference and the field resolution to the non-video signal determining unit 37.

In step S14, the interpolation pair deciding unit 34 decides an interpolation pair based on whether the field correlation is high or low as indicated by the field correlation determining unit 33.

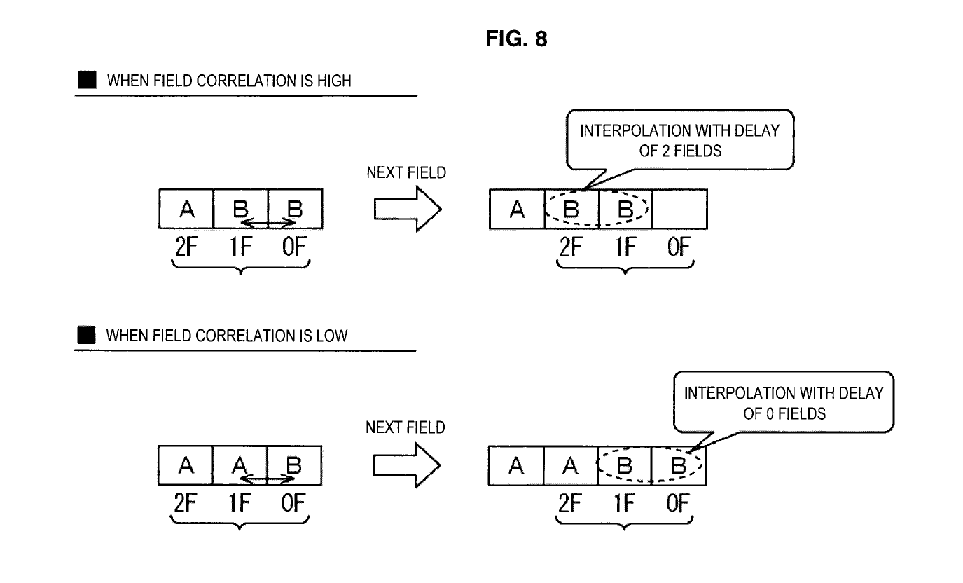

Here, the deciding of the interpolation pair based on whether the field correlation is high or low will be described with reference to FIG. 8.

The upper part of FIG. 8 shows how an interpolation pair is decided when the field correlation is high between the focus field (0 F) and the previous field (1 F). That is, in the upper part of FIG. 8, since 0 F and 1 F are both fields for the image “B”, it is determined that the field correlation is high. After this, at the timing of the next field, the corresponding 1 F and 2 F are decided as the interpolation pair. That is, when the field correlation has been determined to be high, the decision to set the field (2 F) that is two fields behind the focus field (0 F) at the timing of the next field and the field (1 F) that is one field behind as the interpolation pair is made with a delay of one field.

Meanwhile, the lower part of FIG. 8 shows how an interpolation pair is decided when the field correlation is low between the focus field (0 F) and the previous field (1 F). That is, in the lower part of FIG. 8, since 0 F and 1 F are fields of the respective images “B” and “A”, it is determined that the field correlation is low. After this, at the timing of the next field, 0 F and 1 F both become fields for the same image “B” and therefore 0 F and 1 F (i.e., the focus field and the next field that follows the focus field in a time series) are decided as the interpolation pair. That is, when the field correlation has been determined to be low, the decision to set the field (0 F) that is zero fields behind the focus field (0 F) at the timing of the next field and the field (1 F) that is one field behind as the interpolation pair is made with a delay of one field.

Note that the above explanation has a premise that the same field continues at least twice.

In this way, the interpolation pair is decided in real time at the timing of the next field and interpolation pair information expressing the decided interpolation pair is supplied to the interpolation processing unit 35.

Returning to the flowchart in FIG. 6, in step S15, based on the interpolation pair information from the interpolation pair deciding unit 34, the interpolation processing unit 35 interpolates a field using the interpolation pair decided by the interpolation pair deciding unit 34 and supplies the obtained frame of the progressive image to the signal selecting unit 38.

In parallel with this, the interpolation processing unit 36 carries out video interpolation on the inputted interlaced signal and supplies the obtained frame of the progressive signal to the signal selecting unit 38.

In step S16, the non-video signal determining unit 37 determines, based on the field difference and the field resolution from the field correlation determining unit 33, whether the interlaced signal is a non-video signal, or in other words, is a pulldown signal generated by pulling down an interlaced signal according to a specified pulldown sequence.

For example, the non-video signal determining unit 37 determines whether the interlaced signal is a video signal based on the field correlation between the three fields 0 F, 1 F, and 2 F of the interlaced signal.

Here, when a correlation value showing a value of the correlation for the field at time t is expressed as field_crl(t), the correlation value field crl_(t) at time t is expressed by Equation (4) below.

field_crl(t)=(Field Difference)−(Field Resolution)/2 (4)

Note that the field difference and field resolution in Equation (4) refer to the respective values for the field at time t.

As described above, since a video signal is picked up at equal time intervals, when the interlaced signal is a video signal, the ratio of the field difference between 0 F and 1 F to the field difference between 1 F and 2 F will be substantially 1:1 and the ratio between the correlation value field_crl(t) and the correlation value field_crl(t-1) will also be substantially 1:1.

For this reason, the non-video signal determining unit 37 determines that the interlaced signal is not a video signal if a value R showing the ratio of the correlation values between three fields is smaller than a specified threshold. Here, R is expressed as field_crl(t)/field_crl(t−1) when field_crl(t)<field_crl(t−1) and as field_crl(t−1)/field_crl(t) when field_crl(t)>field_crl(t−1).

Note that the non-video signal determining unit 37 carries out this determination continuously for a specified number of fields and if the determination result remains the same during such period, such determination result is outputted. Note also that the threshold used for determination and the period for which the determination continues may be set as appropriate.

It is sufficient for the non-video signal determining unit 37 to determine whether the interlaced signal is a video signal, and aside from making the determination based on the field correlation as described above, the non-video signal determining unit 37 may make the determination of whether the interlaced signal is a video signal according to another method, such as by making a determination by directly comparing field differences.

After this, in step S16, when the interlaced signal is determined to be a non-video signal, the non-video signal determining unit 37 supplies such determination result to the signal selecting unit 38 and the processing proceeds to step S17.

In step S17, based on the determination result from the non-video signal determining unit 37, the signal selecting unit 38 outputs the progressive signal from the interpolation processing unit 35, that is, the frame interpolated with the interlaced signal as the interpolation pair.

Meanwhile, in step S16, when it is determined that the interlaced signal is not a non-video signal, the non-video signal determining unit 37 supplies a determination result showing this to the signal selecting unit 38 and the processing advances to step S18.

In step S18, based on the determination result from the non-video signal determining unit 37, the signal selecting unit 38 outputs the progressive signal from the interpolation processing unit 36, that is, the frame produced by video interpolation of the interlaced signal.

By carrying out the processing described above, since the field correlation is calculated based on the field difference and the field resolution and the interpolation pairs are decided in accordance with whether the field correlation is high or low, it is possible to carry out suitable IP conversion on an input signal of an arbitrary pulldown sequence which includes a pulldown sequence not yet in use, while suppressing the effects of the phase difference characteristic to an interlaced signal. By doing so, it is possible to obtain progressive images of more favorable image quality.

Also, there is no need for a buffer that analyzes pulldown sequences and it is possible to decide the interpolation pair in real time without needing to carry out processing on each pulldown sequence. This means that it is possible to reduce the circuit scale and to raise the immediacy of the processing.

Although the present disclosure is applied to an image processing apparatus that carries out IP conversion in the above description, it is also possible to apply the present disclosure to a configuration that carries out a determination of cadence and to a configuration that carries out frame rate conversion using all of the field differences.

A part of or whole series of processes described above can be executed by any of hardware or software. When a series of processes is executed by software, a program constituting the software is installed from a program recording medium in a computer built in dedicated hardware or, for example, a general-purpose personal computer capable of executing various functions by installing various programs.

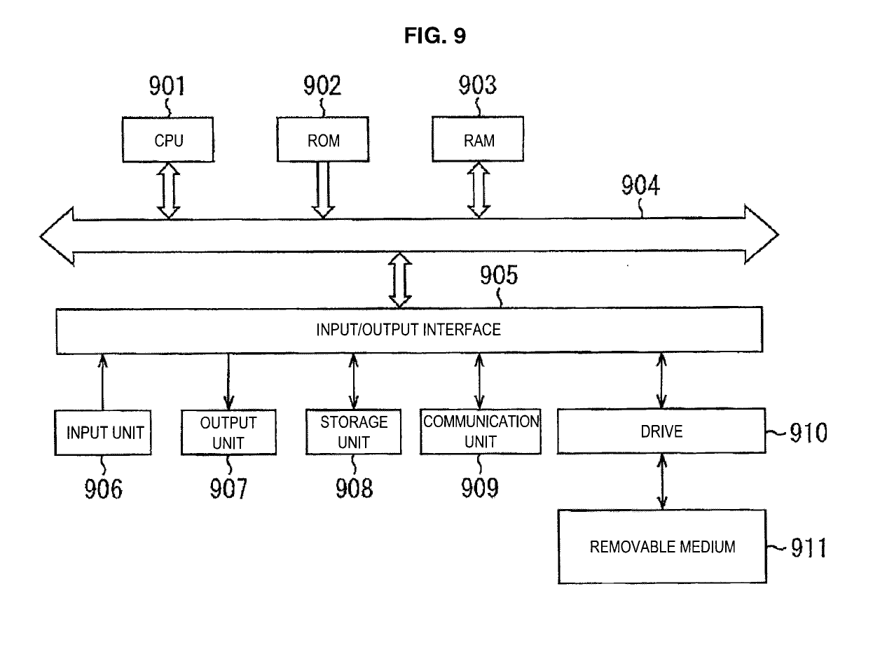

FIG. 9 is a block diagram showing an example of the hardware configuration of a computer which executes the series of processes using a program.

In the computer, a CPU (Central Processing Unit) 901, a ROM (Read Only Memory) 902, and a RAM (Random Access Memory) 903 are connected to each other via a bus 904.

To the bus 904, an input/output interface 905 is also connected. Connected to the input/output interface 905 are an input unit 906 including a keyboard, a mouse, a microphone, and the like, an output unit 907 including a display, a speaker, and the like, a storage unit 908 including a hard disk, a non-volatile memory, and the like, a communication unit 909 including a network interface and the like, and a drive 910 which drives a removable medium 911 such as a magnetic disk, an optical disc, a magneto-optical disk, or a semiconductor memory.

In the thus configured computer, for example, the CPU 901 executes a program stored in the storage unit 908 by loading the program in the RAM 903 via the input/output interface 905 and the bus 904, and thereby performing the above-mentioned series of processes.

The program executed by the computer (CPU 901) is provided by being recorded in the removable medium 911 serving as a package medium including a magnetic disk (including a flexible disk), an optical disc (including a CD-ROM (Compact Disc-Read Only Memory), a DVD(Digital Versatile Disc), and the like), a magneto-optical disk, or a semiconductor memory, or is provided via a wired or wireless transmission medium such as a local area network, the Internet, and digital satellite broadcasting.

The program can be installed in the storage unit 908 via the input/output interface 905, by mounting the removable medium 911 on the drive 910. Further, the program can be received by the communication unit 909 via the wired or wireless transmission medium and can be installed in the storage unit 908. In addition, the program can be installed in the ROM 902 and the storage unit 908 in advance.

It should be noted that the program executed by a computer may be a program that is processed in time series according to the sequence described in this specification or a program that is processed in parallel or at necessary timing such as upon calling.

It should be understood by those skilled in the art that various modifications, combinations, sub-combinations and alterations may occur depending on design requirements and other factors insofar as they are within the scope of the appended claims or the equivalents thereof.

(1) An image processing apparatus that converts an interlaced signal to a progressive signal, including:
a field difference calculating unit calculating a field difference that is a difference between consecutive fields in the interlaced signal;
a field resolution calculating unit calculating a field resolution that is a resolution of the fields in the interlaced signal;
a field correlation determining unit determining correlation between the consecutive fields based on the field difference and the field resolution; and
an interpolated image deciding unit deciding the fields to be used in an interpolation process for obtaining the progressive signal based on a determination result produced by the field correlation determining unit.

(2) An image processing apparatus according to (1),
wherein the field difference calculating unit calculates the field difference between a focus field presently in focus and a previous field that comes before the focus field in a time series,
the field resolution calculating unit calculates the field resolution of the focus field,
the field correlation determining unit determines the correlation between the focus field and the previous field based on the field difference and the field resolution, and
the interpolated image deciding unit is operable when it has been determined that the correlation is higher than a specified threshold to select the focus field and the previous field as the fields to be used in the interpolation process and is operable when it has been determined that the correlation is not higher than a specified threshold to select the focus field and a following field that comes after the focus field in the time series as the fields to be used in the interpolation process.

(3) An image processing apparatus according to (1) or (2), further including:
a signal determining unit determining, based on the determination result of the field correlation determining unit, whether the interlaced signal is a pulldown signal that has been pulled down according to a specified sequence; and
a signal output unit operable when the signal determining unit has determined that the interlaced signal is a pulldown signal, to output the progressive signal obtained by the interpolation process using the fields decided by the interpolated image deciding unit.

(4) An image processing method for an image processing apparatus that converts an interlaced signal to a progressive signal, including:
calculating a field difference that is a difference between consecutive fields in the interlaced signal;
calculating a field resolution that is a resolution of the fields in the interlaced signal;
determining correlation between the consecutive fields based on the field difference and the field resolution; and
deciding the fields to be used in an interpolation process for obtaining the progressive signal based on a determination result produced by the process of determining correlation between the fields

(5) A program causing a computer to carry out processing that converts an interlaced signal to a progressive signal, the processing including:
calculating a field difference that is a difference between consecutive fields in the interlaced signal;
calculating a field resolution that is a resolution of the fields in the interlaced signal;
determining correlation between the consecutive fields based on the field difference and the field resolution; and
deciding the fields to be used in an interpolation process for obtaining the progressive signal based on a determination result produced by the process of determining correlation between the fields.

The present disclosure contains subject matter related to that disclosed in Japanese Priority Patent Application JP 2011-111311 filed in the Japan Patent Office on May 18, 2011, the entire content of which is hereby incorporated by reference.

What is claimed is:

1. An image processing apparatus that converts an interlaced signal to a progressive signal, comprising:
a field difference calculating unit calculating a field difference that is a difference between consecutive fields in the interlaced signal;
a field resolution calculating unit calculating a field resolution that is a resolution of the fields in the interlaced signal;
a field correlation determining unit determining correlation between the consecutive fields based on the field difference and the field resolution; and
an interpolated image deciding unit deciding the fields to be used in an interpolation process for obtaining the progressive signal based on a determination result produced by the field correlation determining unit.

2. An image processing apparatus according to claim 1, wherein the field difference calculating unit calculates the field difference between a focus field presently in focus and a previous field that comes before the focus field in a time series, the field resolution calculating unit calculates the field resolution of the focus field, the field correlation determining unit determines the correlation between the focus field and the previous field based on the field difference and the field resolution, and the interpolated image deciding unit is operable when it has been determined that the correlation is higher than a specified threshold to select the focus field and the previous field as the fields to be used in the interpolation process and is operable when it has been determined that the correlation is not higher than a specified threshold to select the focus field and a following field that comes after the focus field in the time series as the fields to be used in the interpolation process.

3. An image processing apparatus according to claim 1, further comprising:
a signal determining unit determining, based on the determination result of the field correlation determining unit, whether the interlaced signal is a pulldown signal that has been pulled down according to a specified sequence; and
a signal output unit operable when the signal determining unit has determined that the interlaced signal is a pulldown signal, to output the progressive signal obtained by the interpolation process using the fields decided by the interpolated image deciding unit.

4. An image processing method for an image processing apparatus that converts an interlaced signal to a progressive signal, comprising:
calculating a field difference that is a difference between consecutive fields in the interlaced signal;
calculating a field resolution that is a resolution of the fields in the interlaced signal;
determining correlation between the consecutive fields based on the field difference and the field resolution; and
deciding the fields to be used in an interpolation process for obtaining the progressive signal based on the determined correlation between the fields.

5. A program causing a computer to carry out processing that converts an interlaced signal to a progressive signal, the processing including:
calculating a field difference that is a difference between consecutive fields in the interlaced signal;
calculating a field resolution that is a resolution of the fields in the interlaced signal;
determining correlation between the consecutive fields based on the field difference and the field resolution; and
deciding the fields to be used in an interpolation process for obtaining the progressive signal based on a determination result produced by the process of determining correlation between the fields.
